(19) United States
(12) Patent Application Publication
(10) Pub. No.: US 2013/0155658 A1
(43) Pub. Date: Jun. 20, 2013

(54) LIGHTING DEVICE

(71) Applicant: Ping-Yu Chen, Hsinchu County (TW)

(72) Inventor: Ping-Yu Chen, Hsinchu County (TW)

(73) Assignee: YUSHAN SOLID-STATE LIGHTING CO., LTD, Hsinchu County (TW)

(21) Appl. No.: 13/442,929

(22) Filed: Apr. 10, 2012

(30) Foreign Application Priority Data
Dec. 20, 2011 (TW) 100223959

(51) Int. Cl. F21L 4/00; F21V 15/00

(52) U.S. Cl. 362/157; 362/362

(57) ABSTRACT

A lighting device, comprising a housing, a control circuit and a solid-state light emitting unit, is disclosed. The housing includes a receiving space, and the material of the housing is wax. The control circuit is sealed in the receiving space and provides a control signal. The solid-state light emitting unit is sealed in the receiving space and receives the control signal to provide a light.

### CROSS-REFERENCES TO RELATED APPLICATIONS

This application claims priority to Taiwan Patent Application No. 100223959 filed on Dec. 20, 2011, the disclosure of which is incorporated by reference herein in their entirety.

### BACKGROUND OF THE INVENTION

1. Field of the Invention

The present invention relates to a lighting device, and more particularly, to a lighting device in which a solid-state light source is covered by wax.

2. Descriptions of the Related Art

In order to extend applications of lighting products and attract consumers, almost all lighting product manufacturers are making great efforts to research and develop various variable and decorative lighting devices in addition to common lighting devices. Currently, there are various kinds of decorative lighting devices in the market, and appearances and styles of the lighting devices are ever changing in order to satisfy the consumers' demands. Among the conventional lighting devices, most of decorative lighting devices have appearances in the form of bulbs or light boxes. Therefore, the decorative light devices are limited in profile by dimensions and appearances of the bulbs or light boxes and even can only be used for decorating specific sites, or can only emit light for displaying in a large area to achieve a desired visual effect.

For some courtiers or areas are of the humid climate and may rain frequently, lighting devices used outdoors are often exposed to rains or moistures; and furthermore, general decorative lighting devices are often fixed at specific sites in outdoor environments, so they are often exposed to sunlight. These environmental factors make the lighting devices liable to damage or even short-circuits, which tend to shorten the service life and adversely affect the visual appearance thereof

Accordingly, it is highly desirable in the art to provide a lighting device that features a long service life and delivers desirable decorative and waterproof effects.

### SUMMARY OF THE INVENTION

An objective of the present invention is to provide a lighting device which can provide an attractive effect. In such a lighting device, light emitted from a solid-state light source of the lighting device transmits through wax covered around the solid-state light source to generate soft colors. Moreover, because the wax is colorful and plastic, the lighting device can be made to have various appearances. Thereby, a kind of lighting device having an attractive and aesthetic appearance is obtained.

Another objective of the present invention is to provide a lighting device which has a waterproof effect. By using wax to cover a solid-state light source of the lighting device, the lighting device can be prevented from damages in outdoor environments.

To achieve the aforesaid objectives, the present invention provides a lighting device, which comprises a housing, a control circuit and a solid-state light emitting unit. The housing includes a receiving space, and a material of the housing is wax. The control circuit is sealed in the receiving space and provides a control signal. The solid-state light emitting unit is sealed in the receiving space and receives the control signal to provide a light.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a cross-sectional top view of a lighting device according to a first embodiment of the present invention;

FIG. 2 is a cross-sectional side view of the lighting device according to the first embodiment of the present invention;

FIG. 3 is a cross-sectional top view of a lighting device according to a second embodiment of the present invention;

FIG. 4 is a cross-sectional side view of the lighting device according to the second embodiment of the present invention;

FIG. 5 is a schematic partial view of a lighting device according to a third embodiment of the present invention; and

FIG. 6 is a cross-sectional side view of a lighting device according to a fourth embodiment of the present invention.

### DESCRIPTION OF THE PREFERRED EMBODIMENT

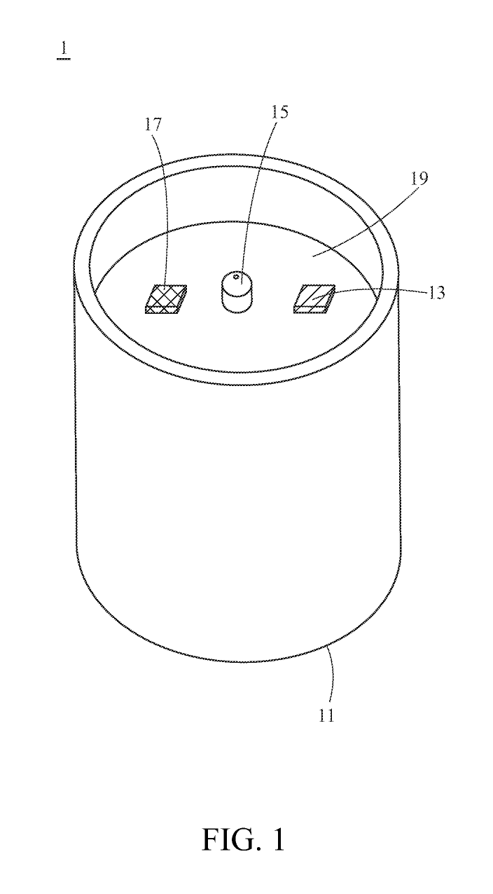

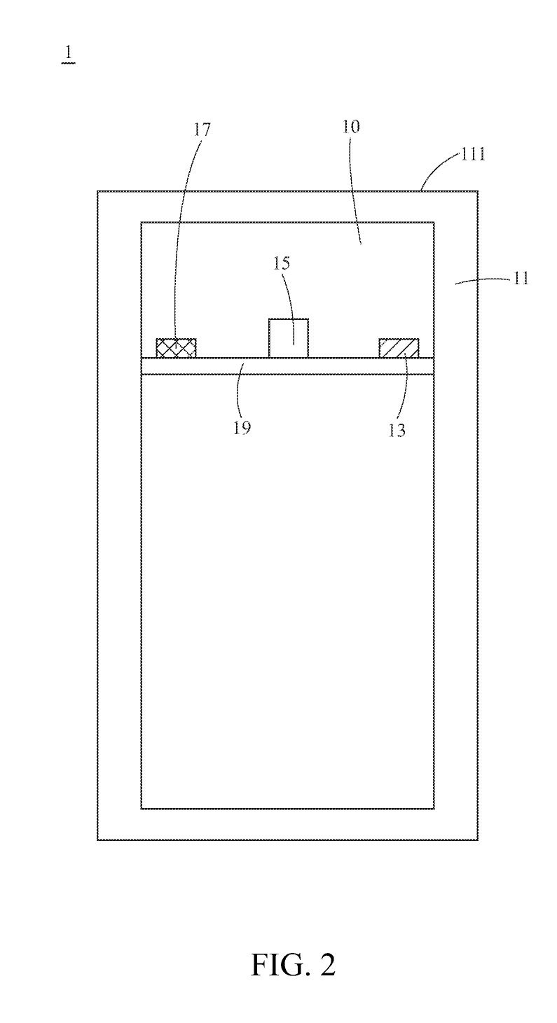

Referring to FIG. 1 and FIG. 2, there are shown a cross-sectional top view and a cross-sectional side view of a lighting device 1 according to a first embodiment of the present invention respectively. As shown, the lighting device 1 comprises a housing 11, a control circuit 13, a solid-state light emitting unit 15, a power storage unit 17 and a substrate 19.

The housing 11 has a receiving space 10 disposed therein and a main lighting surface 111 outside. A shortest distance between the receiving space 10 and the main lighting surface 111 is less than 3 inches; that is, a thickness of the housing 11 at the main lighting surface 111 is less than 3 inches. Furthermore, the housing of the present invention is made of a material of wax to facilitate design and adjustment of the shape and color of the housing.

The substrate 19 is a circuit board and sealed in the receiving space 10. In this embodiment, the control circuit 13, the solid-state light emitting unit 15 and the power storage unit 17 are electrically connected to and disposed on the substrate 19. In other words, the control circuit 13, the solid-state light emitting unit 15 and the power storage unit 17 are also sealed in the receiving space 10 respectively.

The control circuit 13 comprises a microcontroller (not shown). A user may program the control circuit 13 and the microcontroller depending on the practical requirements to provide a control signal to the solid-state light emitting unit 15. The solid-state light emitting unit 15 receives the control signal to provide a light in response to the control signal. In other words, the user may control a flickering frequency and transitions between light states and dark states of the light emitted from the solid-state light emitting unit 15 as desired. The solid-state light emitting unit of the present invention may comprise a light emitting diode (LED) die, a laser emitter or an organic light emitting diode (OLED) die; however, kinds, arrangements and numbers of these elements are all not limited to what described above.

The power storage unit 17 supplies power to the control circuit 13 and the solid-state light emitting unit 15. In this embodiment, the power storage unit 17 is a conventional compact battery, so the lighting device 1 can be used without the need of being connected to the utility power. This facilitates the user in carrying the lighting device 1 about and provides great mobility of the lighting device 1 without the need of a separate power supply.

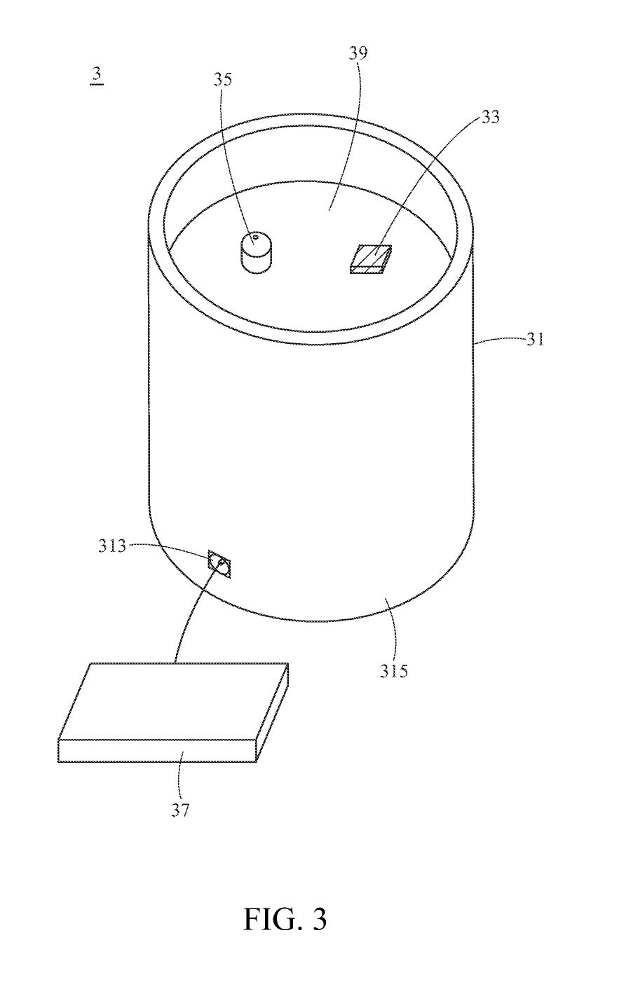

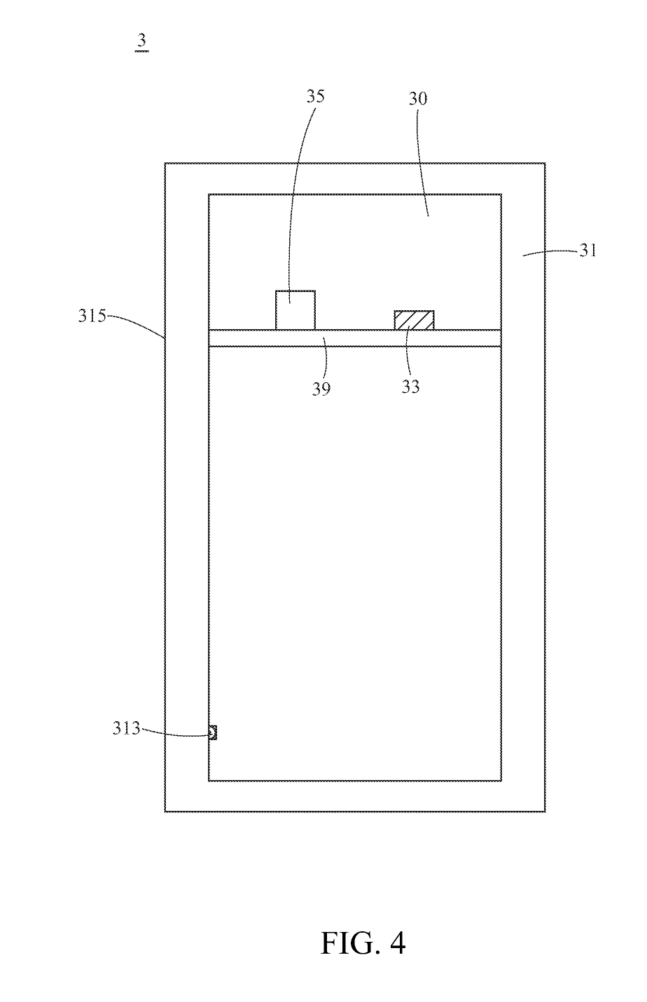

Referring to FIG. 3 and FIG. 4 together, there are shown a cross-sectional top view and a cross-sectional side view of a lighting device 3 according to a second embodiment of the present invention respectively. The lighting device 3 according to this embodiment comprises a housing 31, a control circuit 33, a solid-state light emitting unit 35, a power storage unit 37 and a substrate 39. This embodiment differs from the previous embodiment mainly in arrangement of the power storage unit 37.

As shown, a receiving space 30 of the housing 31 only has the control circuit 33, the solid-state light emitting unit 35 and the substrate 39 disposed therein, while the power storage unit 37 is disposed outside the housing 31. The housing 31 has a connecting portion 313, which is disposed on an outer surface 315 of the housing 31 and electrically connected to the control circuit 33 and the solid-state light emitting unit 35; and the connecting portion 313 is electrically connected to the power storage unit 37. The power storage unit 37 is a battery in this embodiment; however, the power storage unit may also be an electric outlet in other embodiments to facilitate supplying power to the control circuit 33 and the solid-state light emitting unit 35.

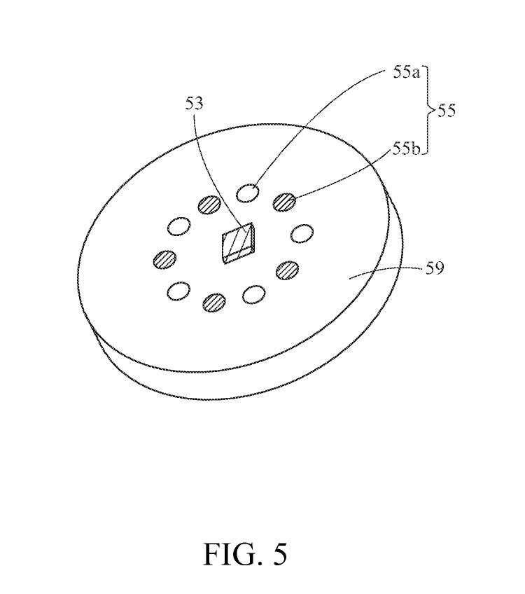

Referring to FIG. 5, there is shown a schematic partial view of a lighting device according to a third embodiment of the present invention; and for the convenience of description, the housing and the power storage unit of the lighting device are not shown. This embodiment differs from the aforesaid embodiments mainly in arrangement of a plurality of solid-state light emitting units 55 in the housing (not shown). As shown, the solid-state light emitting units 55 according to this embodiment include a first solid-state light emitting unit 55a and a second solid-state light emitting unit 55b for providing light of two different colors respectively.

In other words, the solid-state light emitting units of the present invention may be LED dies, laser emitters or OLED dies of a plurality of different colors, and may be arranged in the receiving space depending on the user's requirements. By further programming the microcontroller, the solid-state light emitting units of different colors can emit light intermittently, or only solid-state light emitting units for providing light of particular colors can emit light and so on. Moreover, the lighting device can switch between multiple light emitting modes so that the overall light emitting device can provide more diversified visual effects.

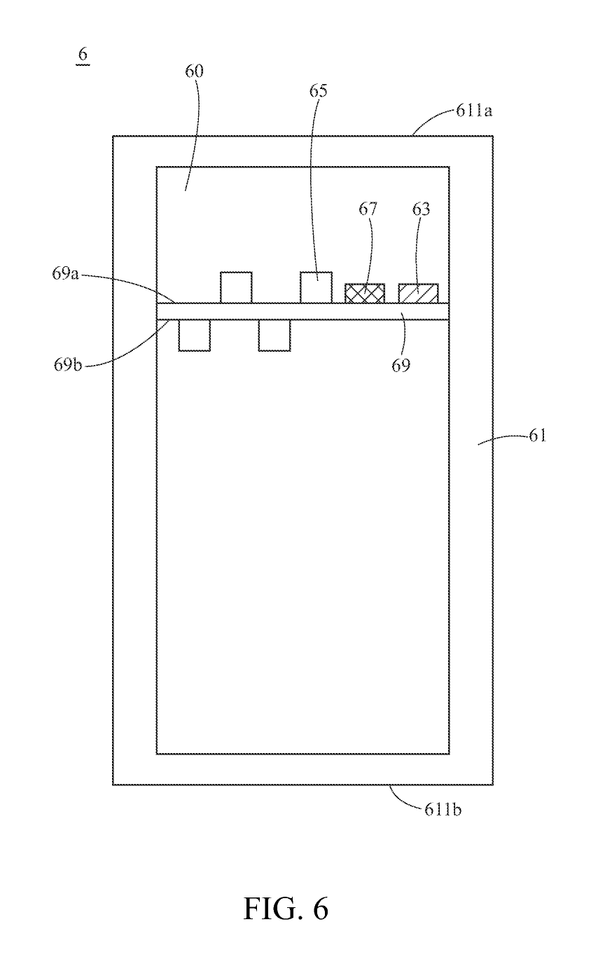

Referring to FIG. 6, there is shown a cross-sectional side view of a lighting device according to a fourth embodiment of the present invention. As shown, the lighting device 6 according to this embodiment also comprises a housing 61, a control circuit 63, a plurality of solid-state light emitting units 65, a power storage unit 67 and a substrate 69. The control circuit 63, the plurality of solid-state light emitting units 65 and the power storage unit 67 on the substrate 69 are also sealed in a receiving space 60 of the housing 61.

In this embodiment, the main lighting surface of the housing 61 may be further divided into an upper lighting surface 611a and a lower lighting surface 611b; and moreover, the plurality of solid-state light emitting units 65 are disposed on an upper surface 69a and a lower surface 69b of the substrate 69 respectively. In other embodiments, different lighting surfaces of the housing may be further designed to have different thicknesses so that light passing through the different surfaces of the housing presents different brightness. Moreover, the plurality of solid-state light emitting units according to this embodiment may also be arranged and controlled depending on the practical requirements so that light provided by the lighting device is more diversified.

According to the above descriptions, the primary objective of the lighting device of the present invention is to provide an attractive effect. In such a lighting device, light emitted from the solid-state light source of the lighting device transmits through wax covered around the solid-state light source to generate soft colors. Moreover, because the wax is plastic, the lighting device can be made to have various appearances. Thereby, a kind of lighting device having an attractive and aesthetic appearance is obtained. Another objective of the present invention is to provide a lighting device which has a waterproof effect. By using wax to cover a solid-state light source of the lighting device, the lighting device can be prevented from damages in outdoor environments.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A lighting device, comprising:
a housing, having a receiving space, and a material of the housing being wax;
a control circuit, being sealed in the receiving space and providing a control signal; and
a solid-state light emitting unit, being sealed in the receiving space and receiving the control signal to provide a light.

2. The lighting device as claimed in claim 1, wherein the housing further has a main lighting surface, and a shortest distance between the receiving space and the main lighting surface is less than 3 inches.

3. The lighting device as claimed in claim 1, further comprising a power storage unit for supplying power to the control circuit and the solid-state light emitting unit.

4. The lighting device as claimed in claim 3, wherein the power storage unit is sealed in the receiving space.

5. The lighting device as claimed in claim 3, wherein the power storage unit is disposed outside the housing, the housing further has a connecting portion, which is disposed on an outer surface of the housing and electrically connected to the control circuit and the solid-state light emitting unit, and the connecting portion is electrically connected to the power storage unit.

6. The lighting device as claimed in claim 1, wherein the control circuit has a microcontroller.

7. The lighting device as claimed in claim 1, wherein the solid-state light emitting unit has at least a light emitting diode (LED) die, a laser emitter or an organic light emitting diode (OLED) die.
